(19) United States
(12) Patent Application Publication
(10) Pub. No.: US 2008/0049773 A1
(43) Pub. Date: Feb. 28, 2008

(54) Radio communication apparatus and radio communication method

(75) Inventors: Yoriko Utsunomiya, Tokyo (JP); Tomoko Adachi, Urayasu-shi (JP)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: KABUSHIKI KAISHA TOSHIBA

(21) Appl. No.: 11/894,157

(22) Filed: Aug. 20, 2007

(30) Foreign Application Priority Data
Aug. 22, 2006 (JP) 2006-225614

(51) Int. Cl. H04L 12/28

(52) U.S. Cl. 370/412

(57) ABSTRACT

A radio communication apparatus includes a first processing unit which performs physical layer protocol processing in order to make a radio communication using at least one first channel having a first frequency bandwidth and a second processing unit which performs physical layer protocol processing in order to make a radio communication using a second channel which has a second frequency bandwidth. The second frequency bandwidth has a bandwidth wider than that of the first frequency band. A transmission frame including either information of a traffic class, a capability of a destination terminal, a recommended bandwidth by the destination terminal, and a time limit to complete transmission of a frame is stored in a queue. A scheduler controls a time when the transmission frame is output from the queue, and which of the first and the second processing units should be used for the output transmission frame, based on the information.

### CROSS-REFERENCE TO RELATED APPLICATIONS

This application is based upon and claims the benefit of priority from prior Japanese Patent Application No. 2006-225614, filed Aug. 22, 2006, the entire contents of which are incorporated herein by reference.

### BACKGROUND OF THE INVENTION

1. Field of the Invention

The present invention relates to a radio communication apparatus and a radio communication method in a system which alternately repeats a period for a narrow-band communication using a single number channel and a period for a broad-band communication using a plurality of channels

2. Description of the Related Art

In recent years, wireless local area networks (LAN) have gained much popularity, and are used in environments ranging from offices to hot spot services in homes or public places. The standards of IEEE 802.11a using a 5 GHz band and IEEE 802.11b/g using a 2.46 GHz band having become the mainstream for wireless LAN, and IEEE 802.11e, which expands a quality of service (QoS) function to a medium access control (MAC) layer, has also been established as a standard. Further, the standardization activities of IEEE 802.11n, expanding both the physical layer and MAC layer while establishing the effective throughput to not less than 100 Mbps as a target, have been proceeding of late.

In IEEE 802.11n, a method of expanding a communication band has been proposed as an approach for realizing an increased transmission speed. According to a system of expanding a frequency bandwidth of a channel, media access control is carried out for different channels intermixed in the same frequency. In this case, the media access control used to make reservations for a plurality of frequency channels in turn one by one enables separating the period for the narrow-band communication using the single channel and the period for the broadband communication using the plurality of channels. In other words, it enables realizing high-speed communication using broadband. The details of such a media access system are given in, for example, JP-A 2004-242893 (KOKAI).

However, when an integrated control station operates a system by using the media access system separating the period for the narrow-band communication and the period for the broadband communication, transmission of a data frame in a stream which has been selected to be transmitted using the narrow-band has to wait for the period for the narrow-band communication. Therefore, there is a possibility that such a media access control system cannot keep delay bound of real time data such as voice. On the contrary, since the data frame of the stream which has selected a transmission rate through the broadband has to wait for the transmission of the frame until it reaches the period for the broadband communication, the same problem occurs. Accordingly, the system that utilizes the media access control system that separates the periods for the narrow-band and the broadband communications poses the possibility of not satisfying the QoS for real time data.

As a conventional example such that time division of media is required and data can be transmitted only in a prescribed period, a wireless LAN which separates a frequency channel into a non-competition access control period and a competition access control period in time division is disclosed in, e.g., JP-A 11-53908 (KOKAI). In the conventional example, restriction conditions such that the frame cannot be transmitted until it reaches the prescribed period are the same as in the case of the narrow-band/wideband communications; however, since the conventional wireless LAN originally determines that which of the non-compensation access control period and the compensation access control period transmits the frame, respectively, so as to satisfy the QoS in accordance with the traffic class of the frame, the delay bound of the real time data is satisfied. That is, since the frequency channel is separated in time division on the basis of the concept of QoS (traffic class), the QoS is satisfied. In contrast, in the case of the narrow-band/broadband communication, since the frequency channel being separated in time division has nothing to do with the concept of QoS (traffic class), a new method of satisfying the QoS is required.

In the meantime, a method for securing the QoS in a system using the media access control system in which the integrated control station separates the periods for the narrow-band and broadband communications is described in, for example, JP-A 2005-267028 (KOKAI). The system described in this document is one which appropriately controls the lengths of the periods of the narrow-band communication and the wideband communication so that the integrated control station satisfies the QoS of terminals to be connected in its own system. However, in the case of the operation of an actual system, it is not preferable for satisfying QoS needs from all terminals to change parameters of an entire system frequently. More specifically, under conditions that the number of the terminals is large, and the number of kinds of applications is also large, it becomes hard for the integrated control station to decide the most suitable length of the communication period.

Therefore, a method to perform scheduling of transmission frames that does not depend on the entire system being controlled by the integrated control station is needed, so as to satisfy QoS at each terminal side. In other words, the system conducts scheduling at each terminal in order to position traffic with high priority, such as real time data, on a concept so as to position traffic with higher priority on a concept to time-share the narrow-band/wideband communication period and transmit it preferentially. To realize such scheduling, it is needed for the system to include a terminal configuration and a scheduler (scheduling algorithm) different from conventional ones.

### BRIEF SUMMARY OF THE INVENTION

A radio communication apparatus according to an aspect of the invention comprises a first processing unit which performs physical layer protocol processing in order to make a radio communication using at least one first channel having a first frequency bandwidth and a second processing unit which performs physical layer protocol processing in order to make a radio communication using a second channel which has a second frequency bandwidth and overlaps with the first frequency band. The second frequency bandwidth has a bandwidth wider than that of the first frequency band. A transmission frame including either information of a traffic class, a capability of a destination terminal, a recommended bandwidth by the destination terminal, and a time limit to complete transmission of a frame is stored in a queue. A scheduler controls timing at which the transmission frame is output from the queue, and which of the first and the second processing units should be used for the output transmission frame, based on the information.

### BRIEF DESCRIPTION OF THE SEVERAL VIEWS OF THE DRAWING

FIG. 1 is a view showing a radio communication system according to the first embodiment;

FIG. 2A and FIG. 2B are schematic views of channels according to the first embodiment;

FIG. 3 is a sequence view for explaining media access control according to the first embodiment;

FIG. 4 is a block diagram of a radio communication apparatus according to the first embodiment;

FIG. 5 is a flowchart showing an operation procedure of a scheduler 1 according to the first embodiment;

FIG. 6 is a flowchart showing another operation procedure of the scheduler 1 according to the first embodiment;

FIG. 7 is a flowchart showing an operation procedure of a scheduler 2 according to the first embodiment;

FIG. 8 is a flowchart showing another operation procedure of the scheduler 2 according to the first embodiment;

FIG. 9 is a flowchart showing a further operation procedure of the scheduler 2 according to the first embodiment;

FIG. 10 is another block diagram of the radio communication apparatus according to the first embodiment;

FIG. 11 is a view for explaining operations of the radio communication apparatus according to the first embodiment;

FIG. 12 is a flowchart showing an operation procedure of a scheduler 1 according to the second embodiment;

FIG. 13 is a flowchart showing another operation procedure of the scheduler 1 of the second embodiment;

FIG. 14 is a block diagram of a radio communication apparatus according to the third embodiment;

FIG. 15 is a flowchart showing an operation procedure of a scheduler 1 according to the third embodiment;

FIG. 16 is a flowchart showing another operation procedure of the scheduler 1 according to the third embodiment;

FIG. 17 is a flowchart showing a further operation procedure of the scheduler 1 according to the third embodiment;

FIG. 18 is a flowchart showing an operation procedure of a scheduler 2 according to the third embodiment;

FIG. 19 is a block diagram of a radio communication apparatus according to the fourth embodiment;

FIG. 20 is a flowchart showing an operation procedure of a scheduler according to the fourth embodiment;

FIG. 21 is another block diagram showing the radio communication apparatus according to the fourth embodiment;

FIG. 22 is a block diagram of a radio communication apparatus according to a fifth embodiment;

FIG. 23 is a flowchart showing an operation procedure of a scheduler 1 according to the sixth embodiment; and

FIG. 24 is a block diagram of a radio communication apparatus according to the eighth embodiment.

### DETAILED DESCRIPTION OF THE INVENTION

The following will describe embodiments of the invention with reference to the drawings.

As for a system in which integrated control makes terminals conduct frame transmissions, a wireless LAN system based on IEEE Std. 802.11-1999 (revision 2003 includes ISO/IEC 8802-11:1999 (E), ANSI/IEEE Std. 802.11 1999 edition, IEEE Std. 802.11a-1999, IEEE Std. 802.11b-1999, IEEE Std. 802.11b-1999/Cor 1-2001 and IEEE Std. 802.11d-2001) will be described. Hereinafter, a basic system configuration will be described on the basis of the IEEE 802.11 wireless LAN system. IEEE 802.11 standard specifications are specifications relating to a physical (PHY) layer and a medium access control (MAC) layer. The following processing is described by mainly paying attention to the processing in the MAC layer.

The IEEE 802.11 standard specifications described herein include amendments of IEEE 802.11 standard specifications and standard specifications to be adopted as recommended practices, etc.

### FIRST EMBODIMENT

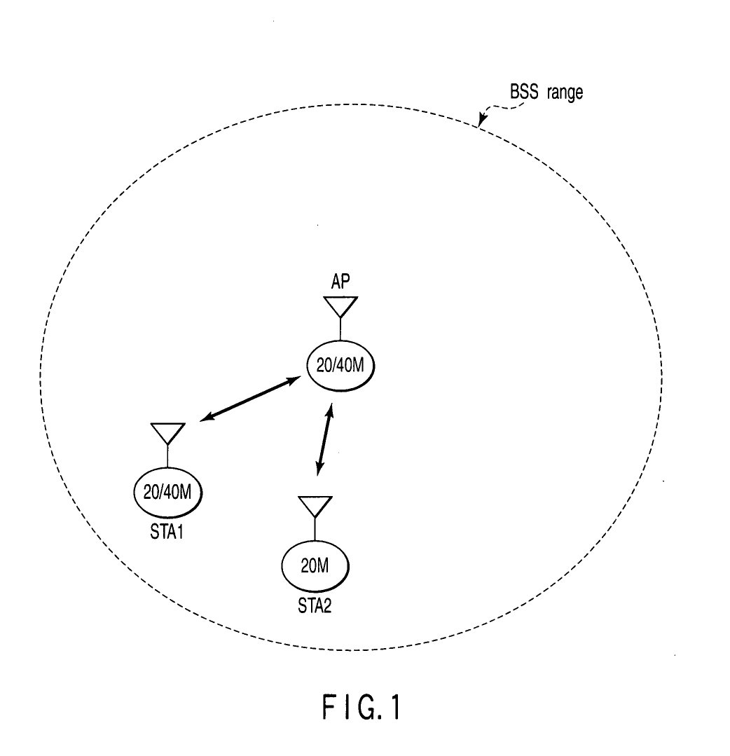

FIG. 1 illustrates a radio communication system regarding the first embodiment. Here, two radio terminals (STA1, STA2) are connected to one access point (AP) so as to form one basic service set (BSS). The BBS is integrally managed by the AP.

The BSS transmits and receives frames by using two kinds of channels differing in frequency bandwidth. The two channels are, namely a first channel with a first communication bandwidth and a second channel with a second communication bandwidth wider than that of the first communication bandwidth. In the embodiment, the first and the second bandwidths are set to, for example, 20 MHz and 40 MHz, respectively.

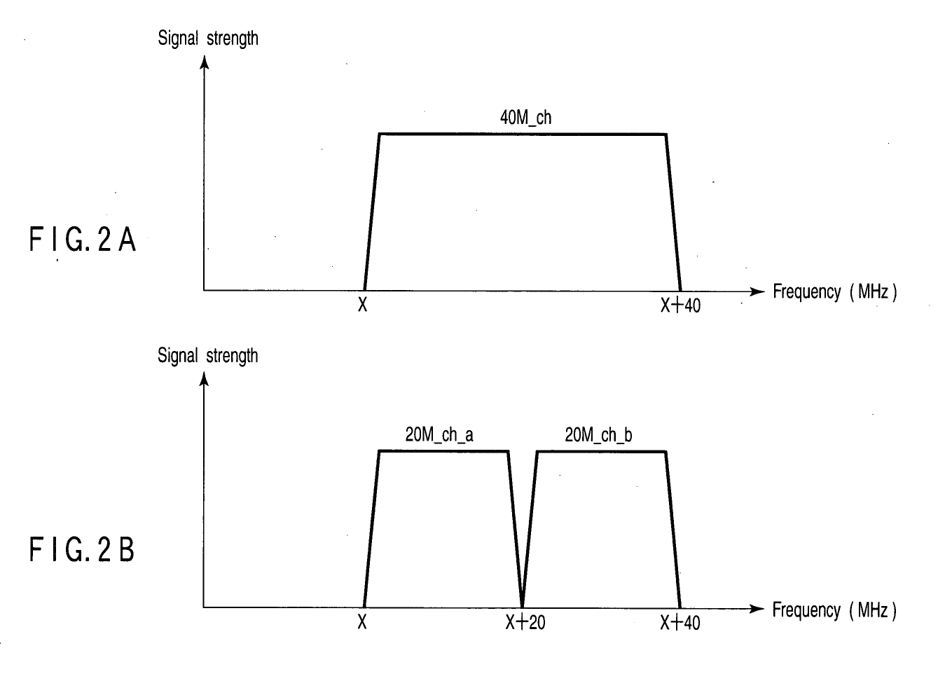

FIG. 2A, and FIG. 2B illustrate schematic views of channels. The BBS includes a channel 20M_ch of 20 MHz using a frequency band of X MHz-(X+20) MHz (FIG. 2B), and a channel 40M_ch of 40 MHz using a frequency band of X MHz-(X+40) MHz (FIG. 2A). Therefore, the frequency bandwidth X MHz-(X+20) MHz is utilized in the channel of 20 MHz and the channel of 40 MHz in an overlapping manner. The channel 20M_ch_b of another channel of 20 MHz using the frequency band of (X+20) MHz-(X+40) MHz forms the channel 40M_ch together with the channel 20M_ch_a. The channel 20M_ch_b is not used independently for a 20 MHz communication at the BSS; however it is used for other BSSs sometimes.

The AP and the STA1 corresponds to both bandwidths of 20/40 MHz, and they can transmit and receive frames using either of the channels 40M_ch and 20M_ch_a. The communication system may use both channels 40M_ch and 20M_ch_a for data frame transmission/reception, and also the communication system may choose to use the channel 40M_ch for a data frame transmission/reception and the channel 20M_ch_a for a control information frame transmission/reception. The STA2 is a terminal corresponding only to the bandwidth of 20 MHz, and conducts a transmission/reception only using the channel 20M\ch_a. The number of sets of the radio terminals to be connected to the AP and the number of sets for each type of the terminals do not limit this invention. For example, the BSS without the STA2 and only with 20/40 MHz terminals is a possible approach.

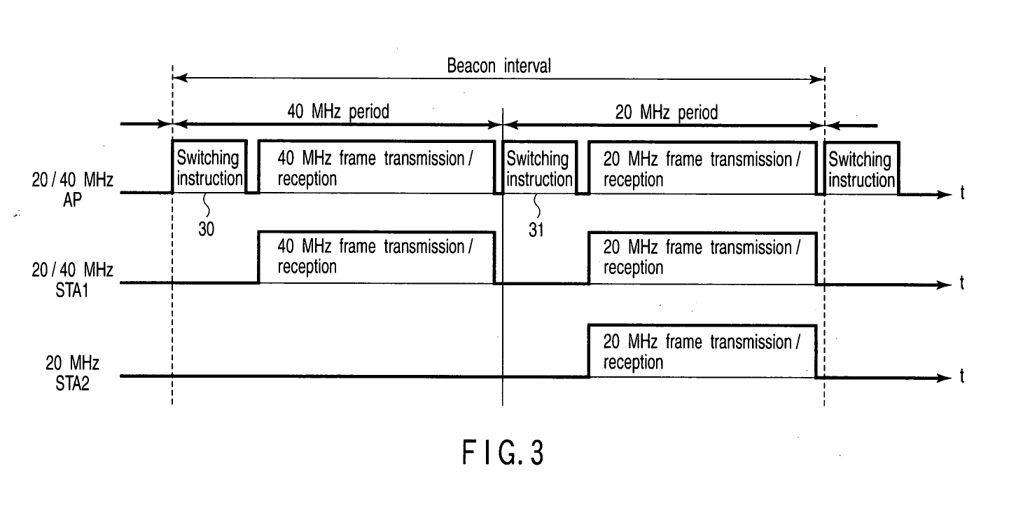

The BBS performs media access control, for example, as depicted in FIG. 3 through the control by the AP. In the example in FIG. 3, the AP instructs the whole BSS to switch the period (20 MHz period) and the period (40 MHz period) by which the 20/40 MHz AP, which is the integrated control station, makes communications by using the channels 20M_ch_a and 40M_ch, respectively. Within both the 20 MHz period and 40 MHz period, either mode (PCF or HCCA), in which the AP poles the STA1, and STA2 to conduct media access control and each terminal conducts media access control evenly, is acceptable.

FIG. 3 illustrates the aspect in which the BSS firstly makes communications through the channel 20M_ch_a, and after this, the BBS returns again to the 20 MHz period while putting the 40 MHz period between the 20 MHz periods.

At the first time point, the 20/40M AP, STA1 and STA2 perform a transmission/reception in the use of the channel 20M_ch_a. In this state, it is presumed that the 20/40M AP has decided to start a procedure of switching the channel 20M_ch_a to the 40M_ch. At this moment, the AP performs a broadcast transmission of a frame 30 by which the AP instructs switching from the channel 20M_ch_a to the channel 40M_ch to all terminals in the BSS. As for the frame 30 to instruct this switching, a beacon frame is useful. When normally receiving the frame 30, the 20/40M AP and the STA1 carry out a transmission/reception by the use of the channel 40M_ch. The STA2 is prohibited to conduct a frame transmission.

On the contrary, for switching the BSS from the 40 MHz period to the 20 MHz period, the AP performs a broadcast transmission of frames 31 to instruct the switching from the channel 40M_ch to the channel 20M_ch_a to all terminals in the BSS. When normally receiving the frames 31, the 20/40M AP and the STA1 perform the transmission/receptions by using the channel 20M_ch_a. When being naturally released a frame transmission/reception inhibition state, or when receiving a transmission/reception inhibition release frame transmitted from the AP, the STA2 starts the communication using the channel 20M_ch_a.

The BSS in FIG. 1 repeats alternately the 40 MHz period and the 20 MHz period for each beacon interval through the control from the AP. Here, an example of time-sharing one beacon interval into the 40 MHz period and 20 MHz period is given, in which both 40 MHz and 20 MHz periods are set irrespective of a beacon period, and switching between the 40 and 20 MHz periods in a plurality of times within one beacon interval is a possible approach.

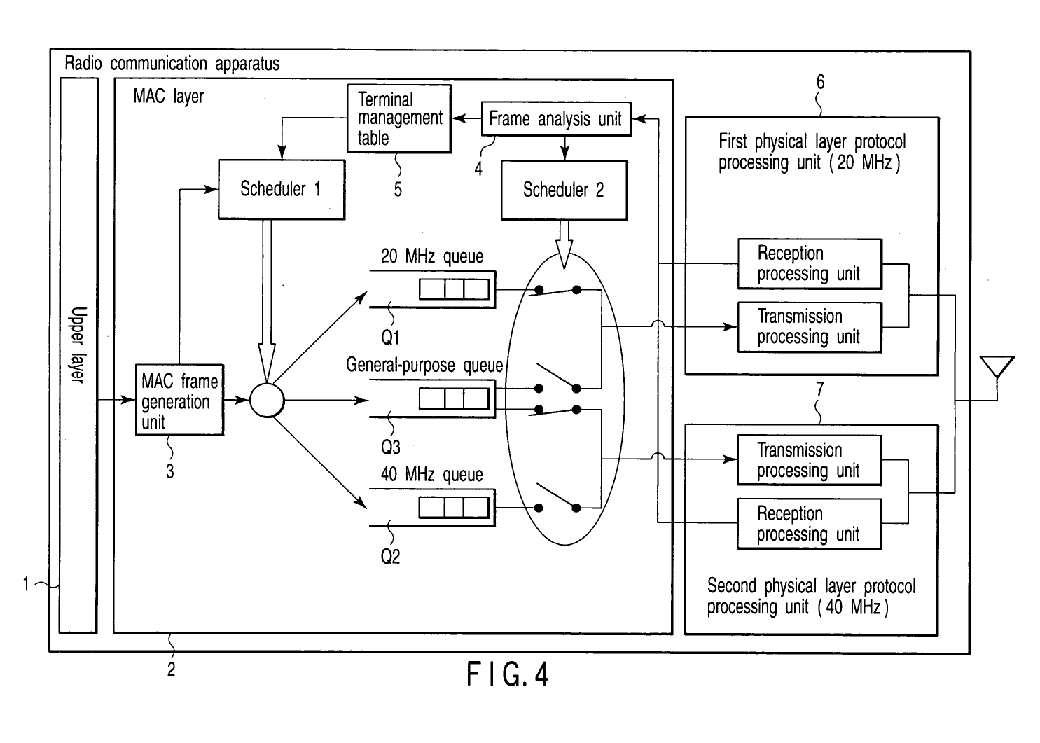

FIG. 4 depicts a terminal configuration of the STA1. The STA1 corresponds to both bandwidths of 20/40 MHz; it transmits/receives the 40 MHz data frames and the 20 MHz data frames during 40 MHz and 20 MHz periods, respectively. Even during a 40 MHz period, the STA1 transmits a control frame and a management frame through the bandwidths of 20 MHz sometimes.

The STA1, as illustrated in FIG. 4, has a plurality of transmission queues buffering the transmission frames therein. In the first embodiment, an example, in which the STA1 has three queues; a 20 MHz queue Q1, a 40 MHz queue Q2 and a general-purpose queue Q3, is taken into account. The 20 MHz queue Q1 is a queue to store frames to be transmitted in the channel 20M_ch_a, the 40 MHz queue Q2 is a queue to store frames to be transmitted in the channel 40M\ch, and the general-purpose queue Q3 is a queue to store frames to be transmittable in either of the channels 20M_ch_a and 40M_ch. Transmission data which has transferred from an upper layer 1 to a MAC layer 2 is formed as a MAC frame by means of a frame generation unit 3 in the MAC layer 2 to be input either of the MHz queue Q1, the 40 MHz queue Q2 or the general-purpose queue Q3 before being transferred to a physical layer, or before being transferred to a hardware unit from a software unit in the MAC layer 2. Each queue may store a frame main body, and may store a pointer indicating a frame stored in other place.

A scheduler 1 decides to which queue the frame is input. Specifically, the scheduler 1 decides this on the basis of information accompanying the generated transmission MAC frame and information described in the frame received from the AP. As an example of the information accompanying the header of the generated transmission MAC frame, a traffic class of the frame described in the MAC header, an address of a destination terminal, and a value of a delay bound are possible information. The delay bound shows a limit time of transmitting the frame. The frames which have not been transmitted after the elapse of this limit time and still remain in the queue are discarded. Depending on a variety of kinds of traffic, the delay bound is different in its size. The delay bound is relatively short as for voice and moving image streaming needing real time transmission. In contrast, the delay bound of traffic of a moving image for storing or the like is longer than that of voice, etc. Some items of the traffic do not have any delay bound. For example, file data does not have a delay bound and even if the file data remains in a queue for a long while, it is not discarded but it is transmitted. As for examples of the information described in the frame received from the AP, the following are given: switching instruction information from the 20 MHz period to the 40 MHz period; switching instruction information from the 40 MHz period to the 20 MHz period; and information showing if the transmission/reception of the data frame is currently in the 20 MHz period or the 40 MHz period. After a frame analysis unit 4 takes out the information described in the frame received from the AP, a terminal management table 5 may store the information therein. The table 5 is a memory to store information about its own terminal, the AP, and other terminals, and management information of the BSS, etc.

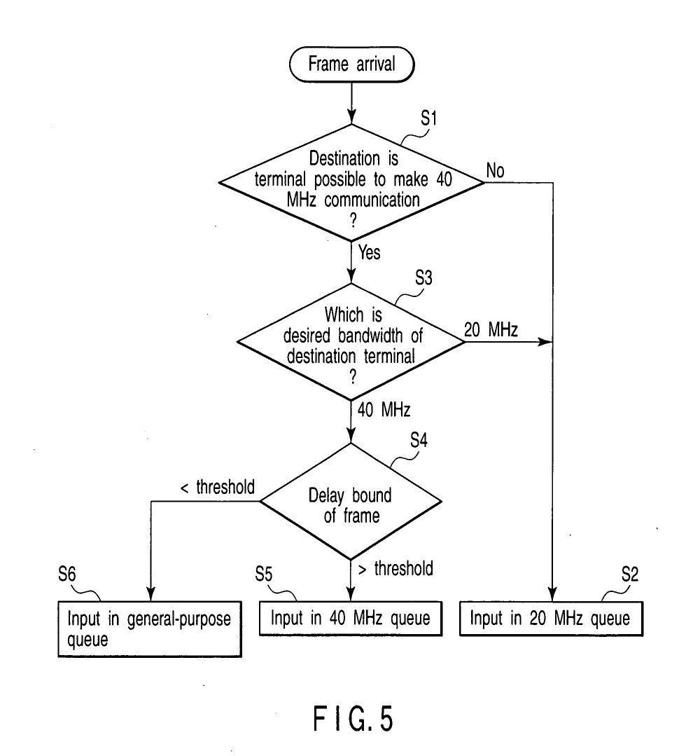

FIG. 5 illustrates an example of a method for deciding to which queue the frame is input by the scheduler 1. The scheduler 1 firstly refers to the table 5 by means of the transmission destination address of the frame to acquire the information showing that the transmission destination terminal is a terminal which can transmit/receive only in the bandwidth of 20 MHz, or a terminal which can transmit/receive in the bandwidth of 40 MHz as well. If the transmission destination terminal is a terminal transmittable/receivable only in the bandwidth of 20 MHz (No, in step S1), the scheduler 1 inputs the frame in the 20 MHz queue Q1 (step S2). If the destination terminal is a terminal that can transmit/receive the frame also in the bandwidth of 40 MHz, the scheduler 1 refers to the table 5 again to acquire the information showing which of the 20 MHz and 40 MHz bandwidths is required by the transmission destination terminal. If the destination terminal desires to receive the frame through the bandwidth of 20 MHz (step S3), the scheduler 1 inputs the frame to the 20 MHz queue Q1 (step S2). If the destination terminal desires to receive the frame through the bandwidth of 40 MHz (step S4), the scheduler 1 checks the information accompanying the frame to compare the delay bound of the frame with a prescribed threshold (step S4). If the delay bound is larger than the threshold, the scheduler 1 inputs the frame to the 40 MHz queue Q2 (step S5), if it is not larger than the threshold, the scheduler 1 inputs the frame to the general-purpose queue Q3 (step S6). However, as for the frame of traffic having no delay bound, the scheduler 1 presumes that the delay bound is infinity to input the frame in the 40 MHz queue Q2. The value of the delay bound can be described in the header of the frame and stored in the memory for each frame as the information of the frames to be managed. Thereby, the frame with a short delay bound and intended to be transmitted in a hurry is input in the general-purpose queue Q3. As to the threshold value, the MAC layer 2 may set a value corresponding to a situation (congestion level of each queue, communication path conditions to destination terminal, etc.), and may select an appropriate value among prescribed values in response to the situation. Or the threshold value may be selected appropriately among preset values in response to the situation, and may always be a fixed value.

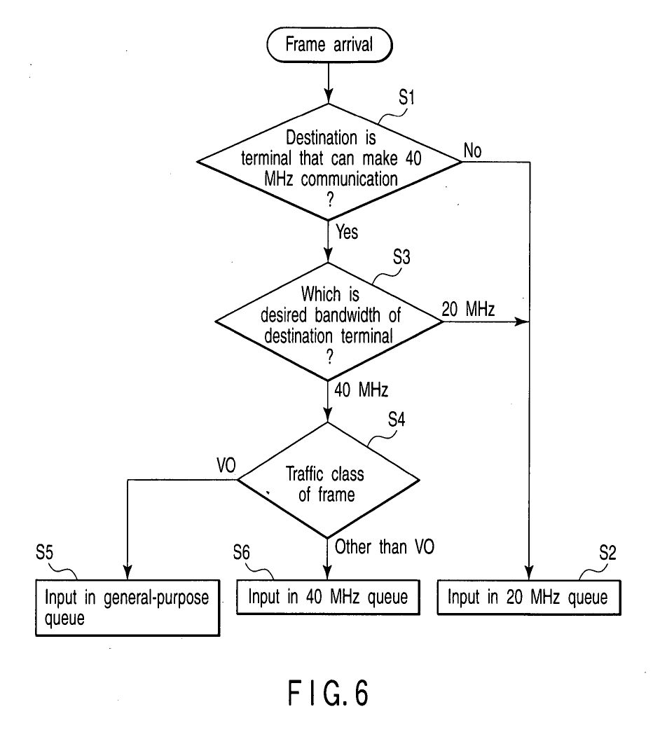

FIG. 6 illustrates another method by which the scheduler 1 decides the queue to which the frame is input. An operation procedure, from the time when the scheduler 1 refers to the terminal management table 5 to check a reception desiring bandwidth of the destination terminal, and further, if the destination terminal desires the reception in the bandwidth of 20 MHz, until the scheduler 1 inputs the frame into 20 MHz queue (steps S1-S3), is the same as that of FIG. 5. If the destination terminal desires the reception in the bandwidth of 40 MHz, the scheduler 1 further checks the information accompanying the frame to check the traffic class of the frame (step S4). The traffic frame is frequently described in the header in the frame. If the traffic class is, for example, a voice (VO), the scheduler 1 inputs the frame in the general-purpose queue Q3 (step S5), and if it is a traffic class other than the voice (VO), the scheduler 1 inputs the frame in the 40 MHz queue Q2 (step S6). A determination reference of the traffic class is not limited to the voice (VO). For instance, operations may be as follows: if the traffic class is the voice (VO), or a moving image (VI), the frame is input in the general queue Q3; and if it is other than the voice (VO) and the moving image (VI), the frame is input in the 40 MHz queue Q2. Thereby, like the method illustrated in FIG. 5, the frame needing the real time characteristics similar to that of the voice (VO) is input in the general-purpose queue Q3.

The frames which have been input in the 20 MHz queue Q1, 40 MHz queue Q2 and general-purpose queue Q3 are taken out, based on the instructions from the scheduler 2. The scheduler 2 decides from which of the MHz queue Q1, 40 MHz queue Q2 and general-purpose queue Q3 the frame should be taken out on the basis of the information whether the system is currently in the MHz period or the 40 MHz period. The frame analysis unit 4 may analyze the switching instruction frame received from the AP to extract the information telling that the system is in the 20 MHz period or 40 MHz period and transmit it to the scheduler 2, or may store it in the terminal management table 5 once, and the scheduler 2 may refer to the table 5.

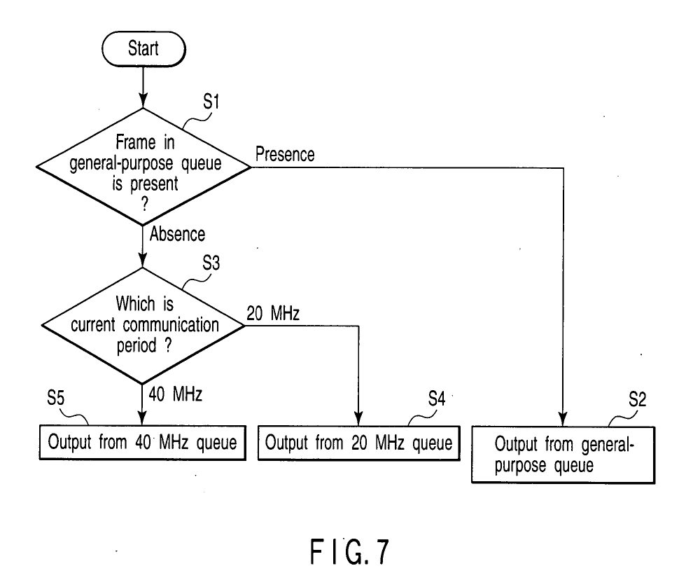

FIG. 7 depicts an example of a method that the scheduler 2 performs to determine which queue should output the frame. The scheduler 2 firstly checks the presence or absence of the transmission frame from the general-purpose queue Q3 (step S1). If the transmission frame is in the general-purpose queue Q3, the scheduler 2 extracts the frame from the general-purpose queue Q3 (step S2), and transfers the frame to the corresponding physical layer protocol processing unit (or hardware unit in MAC layer) in response to whether the system is currently in the 20 MHz period or in the 40 MHz period. If it is in the 20 MHz period, the scheduler 2 transfers the frame to a physical layer protocol processing unit 6 of 20 MHz, and if it is in the 40 MHz period, the scheduler 2 transfers the frame to a physical layer protocol processing unit 7 of 40 MHz. The processing unit 6 of 20 MHz performs physical layer protocol processing to make a communication by the use of the channel 20 MHz_ch_a with the communication bandwidth of 20 MHz. The processing unit 7 conducts physical layer protocol processing to make a communication by using the channel 40 MHz_ch with the communication bandwidth of 40 MHz. In a implementation, the processing units 6 and 7 often share a circuit with each other and are not always independent from each other.

If the transmission frame is not present in the general-purpose queue Q3, in response to whether the system is currently in the 20 MHz period or in the 40 MHz period the scheduler 2 takes out the frame from the relevant queue (step S3). If the system is in the MHz period, the scheduler 2 extracts the frame from the 20 MHz queue Q1 (step S4), and transfers it to the physical layer protocol processing unit 6 of 20 MHz. If the system is in the 40 MHz period, the scheduler extracts the frame from the 40 MHz queue Q2 (step S5), and transfers it to the physical layer protocol processing unit 7 of 40 MHz. Thereby, the scheduler 2 may output the frame of the general-purpose Queue Q3 in either of 20 and 40 MHz periods by giving priority over the frame. That is, the scheduler 2 may preferentially transmit the frame such as a frame with a short delay bound, and frames requiring real time characteristics, such as those of voice and moving images.

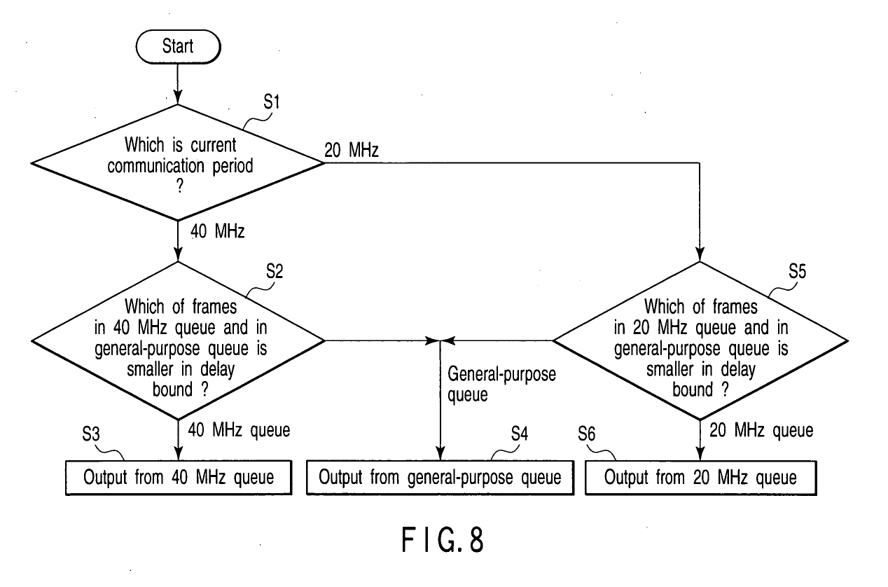

FIG. 8 illustrates another method by which the scheduler 2 decides from which queue the frame should be output. In the case of the current communication period being in the 40 MHz communication period (40 MHz in step S1), the scheduler 2 checks the 40 MHz queue Q2 and the general-purpose queue Q3. If either the queue Q2 or the queue Q3 is empty, the scheduler 2 takes out the frame from the queue that is not empty. In the case of presence of frames in both queues Q2, Q3, the scheduler 2 compares the delay bound of the frames of the respective queues one another, to output the frame with the shorter delay bound preferentially (step S2). For instance, if the value of the delay bound of the frame stored in the 40 MHz queue Q2 is smaller than that of the frame stored in the general-purpose queue Q3, the frame stored in the 40 MHz queue Q2 is output in advance of that stored in the general-purpose queue Q3 (step S3). On the contrary, if the value of the delay bound of the frame stored in the general-purpose queue Q3 is smaller than that of the frame stored in the 40 MHz queue Q2, the frame stored in the general-purpose queue Q3 is output in advance of that stored in the 40 MHz queue Q2 (step S4). Here, if either of the frames to be compared is traffic not having a delay bound, the delay bound of its frame is assumed to be infinity, and a frame having such delay bound is preferentially output from the queue. The frame output in the step S3 or S4 is transferred to the processing unit 7 with 40 MHz.

If the current communication period is the 20 MHz communication period (20 MHz in step S1), the scheduler 2 checks the 20 MHz queue Q1 and the general-purpose queue Q3. If either of the queue Q1 or Q3 is empty, the scheduler 2 takes out the frame from the queue that is not empty. If the frames are present in both queues Q1 and Q3, the scheduler 2 compares the delay bound of the frames of the respective queues one another, to output the frame with the shorter delay bound preferentially (step S5). For example, if the value of the delay bound of the frame stored in the 20 MHz queue Q1 is smaller than that of the delay bound of the frame stored in the general-purpose queue Q3, the frame stored in the 20 MHz queue Q1 is output in advance of the frame stored in the general-purpose queue Q3 (step S6). On the contrary, if the value of the delay bound of the frame stored in the general-purpose queue Q3 is smaller than that of the delay bound of the frame stored in the 20 MHz queue Q1, the frame stored in the general-purpose queue Q3 is output in advance of the frame stored in the 20 MHz queue Q1 (step S4). Here, if either of the frames to be compared is traffic having no delay bound, the delay bound of the frame is presumed to be infinity, the frame having the delay bound is output preferentially from the queue. The frame which has been output in the step S6 or the step S4 is transferred to the physical layer protocol processing unit 6 of 20 MHz.

Performing an operation like this enables the frame having the delay bound and also having shorter one in both 20 and 40 MHz periods to be transmitted preferentially.

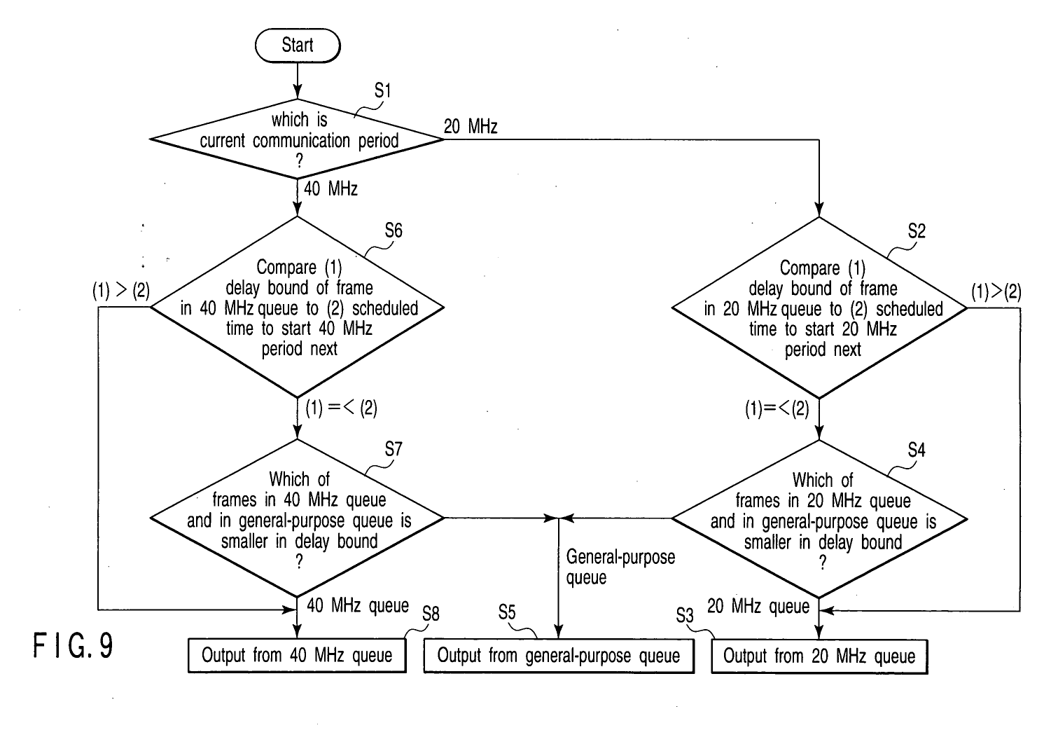

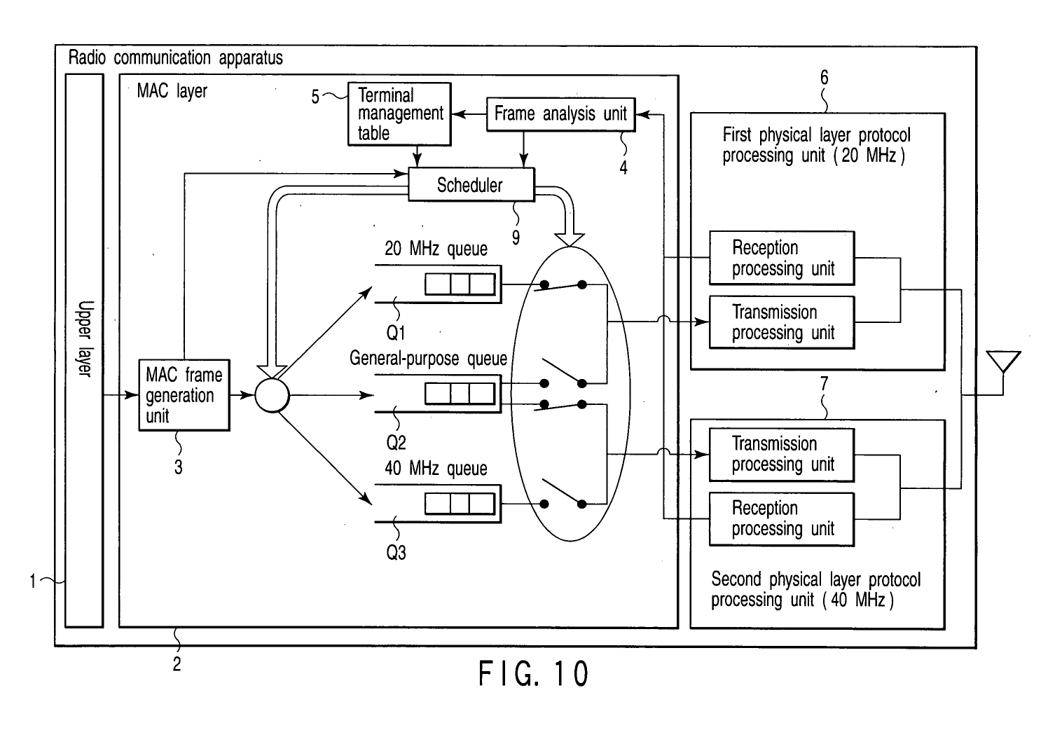

FIG. 9 shows another method in which the scheduler 2 decides from which queue the frame is output. If the current communication period is the 40 MHz communication period (40 MHz in step S1), the scheduler 2 checks the 40 MHz queue Q2 and the general-purpose queue Q3. If the current communication period is the MHz communication period (20 MHz in step S1), the scheduler 2 checks the 20 MHz queue Q1 and the general queue Q3. If either queue Q1 or Q3 is empty, the scheduler 2 takes out the frame from the queue that is not empty, in the same manner as in FIG. 8. The method in FIG. 9 differs from that of FIG. 8 in the selection method of the queue from which the frame is output in the case of presence of frames in both queues Q1 and Q3.

That is to say, in the example in FIG. 9, for example, if the current communication period is the MHz communication period (20 MHz in step S1), the scheduler 2 compares between a scheduled time after the completion of the 20 MHz communication period and the 20 MHz communication period starts again through the 40 MHz communication period with the time of the delay bound of the frame of the 20 MHz queue Q1 (step S2), and if the time of the delay bound of the frame of the MHz queue Q1 is earlier than the scheduled time to start the 20 MHz communication period again next, the frame is discarded if it is not transmitted during the current 20 MHz communication period, and the scheduler 2 transmits the frame of the 20 MHz queue Q1 preferentially (step S3).

In a case other than such a case above, like the example shown in FIG. 8, the scheduler 2 preferentially outputs the frame with an early delay bound (steps S4, S5). The frame which has been output from the queue is transferred to the processing unit 6. However, if the top frame of the 20 MHz queue Q1 is the traffic having no delay bound in the step S2, since the scheduler 2 assumes that the delay bound of the frame is infinity, the scheduler 2 determines that the delay bound in the top frame of the general-purpose queue Q3 is smaller in the step S4, and outputs the frame from the general-purpose queue Q3.

Similarly, during the 40 MHz period (40 MHz in step S1), the scheduler 2 compares the scheduled time when the next 40 MHz communication period is started again after the completion of the 40 MHz communication period through the 20 MHz period with the time of the delay bound of the frame in the 40 MHz queue Q2 (step S6). As a result, if the time of the delay bound of the frame in the 40 MHz queue Q2 is earlier than the scheduled time to start the next 40 MHz communication period again, the frame is discarded if it is transmitted in the current 40 MHz communication period, and the scheduler 2 outputs the frame in the 40 MHz queue Q2 preferentially (step S8).

In a case other than such a case above, like the example shown in FIG. 8, the scheduler 2 preferentially outputs the frame of which the time of the delay bound is earlier (steps S7, S5). The frame output from the queue is transferred to the processing unit 4 of 40 MHz. However, if the head frame of the 40 MHz queue Q2 is the traffic having no delay bound in the step S6, the scheduler 2 assumes that the delay bound of the frame is infinity, then advances to the next step, step S7. If the delay bound is assumed as infinity, the scheduler 2 determines that the delay bound at the top frame in the general-purpose queue Q3 is smaller in step S7, and the scheduler 2 outputs the frame from the general-purpose queue Q3.

By the procedure given above, the frame of the general-purpose queue Q3 can be transmitted for either of the 20 and 40 MHz communication periods, so that the system can satisfy QoS under consideration to give priority to the delay bound of the frame in the 20 MHz queue Q1 and in the 40 MHz queue Q2 which have to wait the transmission of the frame until the next communication period starts.

The scheduled time to start the 40 MHz or the MHz communication period again may be notified from the AP, and the information may be collected by the use of the standard such as IEEE 802.11k. The STA1 itself observes to store the switching period between the MHz period and the 40 MHz period, and may calculate the scheduled time through estimation.

FIG. 4 having shown the scheduler 1 and the scheduler 2 in the respective block diagrams, one scheduler 9, as shown in FIG. 1, may have both functions of the schedulers 1 and 2.

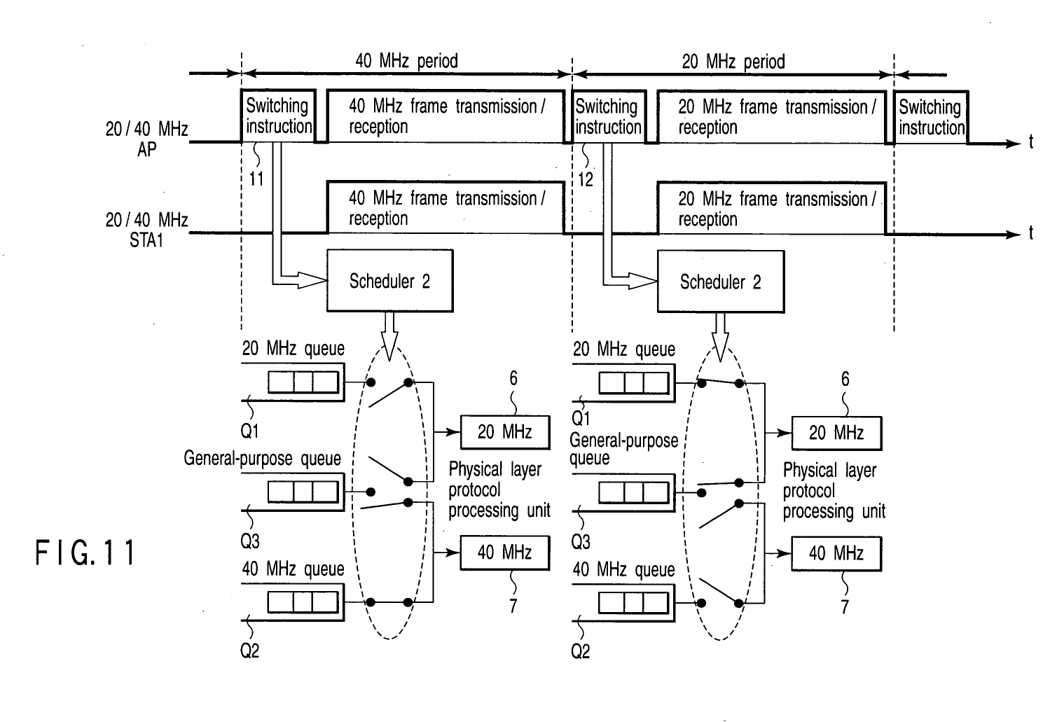

Hereinafter, input/output operations of the frames to the 20 MHz queue Q1, 40 MHz queue Q2 and general-purpose queue Q3 of the STA1 will be described while associating with the switching operations of the 20 MHz period/40 MHz period of the whole BSS by the control from the AP with reference to the FIG. 4 and the FIG. 11.

At first, when the scheduled time to switch from the 20 MHz period to the 40 MHz period is reached, the AP performs the broadcast transmission of the switching instruction frame 11. The 20/40 MHz STA1 receives the frame 11, and the frame analysis unit 4 recognizes that the frame 11 is the switching instruction from the MHz period to the 40 MHz period. The frame analysis unit 4 notifies the fact that the communication period has shifted to the 40 MHz period to the scheduler 2. At this moment, the terminal management table 5 may store the information of the shift. During 40 MHz period, the scheduler 4 inputs the transmission frame to any one of the 20 MHz queue Q1, 40 MHz queue Q2 or general-purpose queue Q3 in accordance with the algorithm in FIG. 5 or FIG. 6. The scheduler 2 outputs the transmission frame from the 40 MHz queue Q2 or the general-purpose queue Q3 in accordance with any of the algorithms in FIG. 7, 8 or 9. The output frame is transferred to the processing unit 7 of 40 MHz.

Next, when the scheduled time of switching from the 40 MHz period to the 20 MHz period is reached, the AP conducts a broadcast transmission of the switching instruction frame 12. The 20/40 MHz STA1 receives the frame 12. Then, the frame analysis unit 4 recognizes that it is the switching instruction from the 40 MHz period to the 20 MHz period. The analysis unit 4 notifies that the communication period has shifted to the 20 MHz period to the scheduler 2. At this moment, the table 5 may store the fact of the shift. During the 20 MHz period, the scheduler 1 inputs the transmission frame from any one of the 20 MHz queue Q1, 40 MHz queue Q2 and general-purpose queue Q3 in accordance with the algorithm in FIG. 5 or FIG. 6. The scheduler 2 operates in accordance with any one of algorithms in FIGS. 7, 8 and 9 to output the frame from the 20 MHz queue Q1 or the general-purpose queue Q3. The output frame is transferred to the processing unit 6 of 20 MHz.

When using any of the algorithms in FIGS. 7, 8 and 9, the scheduler 2 operates so as to output the frame from the 40 MHz queue Q2 or the general-purpose queue Q3 during the 40 MHz period, and from the 20 MHz queue Q1 or the general-purpose queue Q3 during 20 MHz period by using the switching instruction frame from the AP as a trigger. Thereby, the scheduler 2 may exclusively control the 20 MHz queue Q1 and the 40 MHz queue Q2 in the STA 1 in accordance with the time-shared 20/40 MHz communication periods.

In the first embodiment, the example in which a radio communication apparatus has three queues; the MHz queue Q1, 40 MHz queue Q2 and general-purpose queue Q3 has been described, but the number queues is not limited to three. The number of each of individual queues; 20 MHz queue Q1, 40 MHz queue Q2 and general-purpose queue Q3, is not limited to one, and the apparatus may have more than one of each queue. For instance, each queue may be further segmentalized for each traffic class, and the apparatus may include a 20 MHz queue Q1 for voice traffic, a 20 MHz queue Q2 for moving image traffic, a 20 MHz queue Q1 for best effort traffic, a 20 MHz queue Q1 for control information, a 40 MHz queue Q2 for voice traffic, a 40 MHz queue Q2 for moving image, a 40 MHz queue Q2 for best effort traffic, a 40 MHz queue Q2 for control information, and a general-purpose queue Q3.

According to the embodiment, providing the general-purpose queue Q3, and controlling exclusively the 20 MHz queue Q1 and the general-purpose queue Q3, and the 40 MHz queue Q2 and the general-purpose queue Q3 by the scheduler 1 and the scheduler 2, respectively, enables the apparatus to satisfy the QoS of data that requires real time characteristics, such as voice, even under the restriction in which the apparatus can transmit the data only in a prescribed period.

Thus, the first embodiment given above, in a 20/40 MHz coexistence system, a radio communication apparatus reduces an increase in time of waiting for a frame transmission caused from time-sharing of the 20/40 MHz communication period, and can satisfy the QoS of the real time data, more specifically, the delay bound.

### SECOND EMBODIMENT

The configuration of the radio system of the second embodiment is the same as that of the first embodiment. The frequency channel arrangement of the second embodiment is the same as that of FIG. 2, the system of the media access control is the same as that of FIG. 3, and the configuration of the radio communication apparatus is the same as that of FIG. 4. The second embodiment is different from the first embodiment in a specific concrete content of a method in which the scheduler 1 decides in which queue to input the frame.

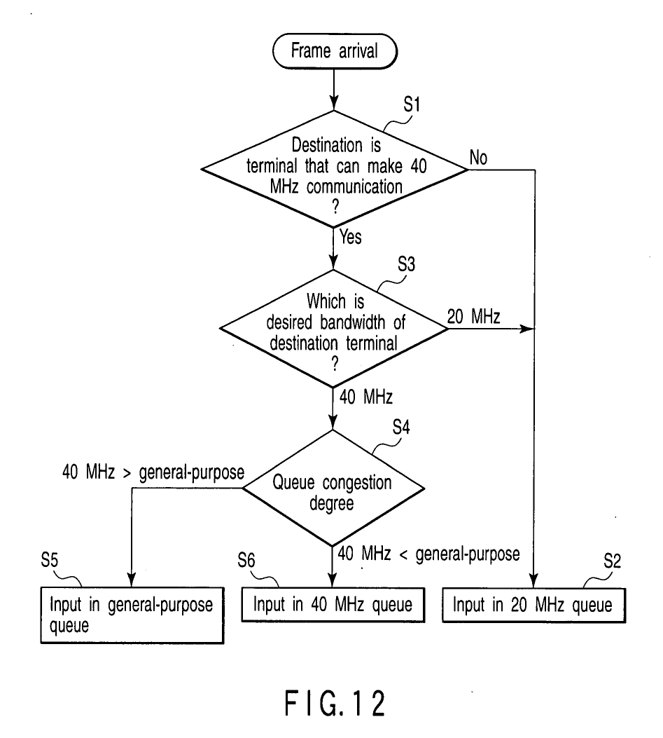

FIG. 12 shows a flowchart of operations of the scheduler 1 in the second embodiment. The scheduler 1 firstly checks a transmission destination address of the frame to acquire information as to whether the transmission destination terminal is a terminal that can transmit/receive the frame only in the bandwidth of 20 MHz, or transmit/receive it also in the bandwidth of 40 MHz by referring to the terminal management table 5 (step S1). If the terminal is one that can transmit/receive the frame only at the bandwidth of 20 MHz, the scheduler 1 inputs the frame in the 20 MHz queue Q1 (step S2). If the terminal is one that can transmit/receive the frame not only at the bandwidth of 20 MHz but also at the bandwidth of 40 MHz, the scheduler 1 refers to the table 5 to acquire the information about which of the bandwidths of 20 MHz and 40 MHz is desired to be used for receiving the frame by the terminal (step S3). If the terminal desires to receive the frame through the bandwidth of 20 MHz (20 MHz in step S3), the scheduler 1 inputs the frame in the 20 MHz queue (step S2).

If the terminal desires to receive the frame through the bandwidth of 40 MHz, the scheduler 1 compares “the averaged time from the time when the frame is input to a queue up to the time when the frame is output from the queue (hereinafter referred to as ‘queue congestion level’)” between the 40 MHz queue Q2 and the general-purpose queue Q3 (step S4), and inputs the frame in the queue lower in congestion level (shorter in the foregoing average time). Comparing the congestion level at each queue enables transmitting the frame to be preferentially transmitted from the queue after a shorter waiting time. It is useful to use an index, such as “number of frames present in queue”, “number of total data bytes in queue”, “number of frames in queue/queue length”, “number of total data bytes in queue/queue length”, or “empty size of queue” as a queue congestion level.

If the queue congestion level of the 40 MHz queue is higher than that of the general-purpose queue (40 MHz queue>general-purpose queue in step S4), because the throughput of the channel 40 MHz_ch is low resulting from being short in a length of a 40 MHz period, or poor in propagation conditions, there is some possibility that the frame in the 40 MHz queue Q2 is hardly transmitted and remains therein. In such a case, the scheduler 1 inputs the frame in the general-purpose queue Q3 with a relatively lower queue congestion level (step S5). On the contrary, if the queue congestion level of the general-purpose queue Q3 is higher than that of the 40 MHz queue Q2 (40 MHz queue>general-purpose queue), the cause may be that the throughput of the channel 20 MHz_ch_a is low, a general amount of 20 MHz frames is large, or a traffic amount of the channel 20 MHz_ch_a is large, etc. In this case, the scheduler 1 inputs the frame in the 40 MHz queue Q2 with a relatively lower queue congestion level (step S6).

Thereby, the scheduler 1 can select the queue from which the frame can be transmitted after a shorter waiting time, and can reduce the frame discarding rate at the queue to improve a use efficiency and throughput in a channel.

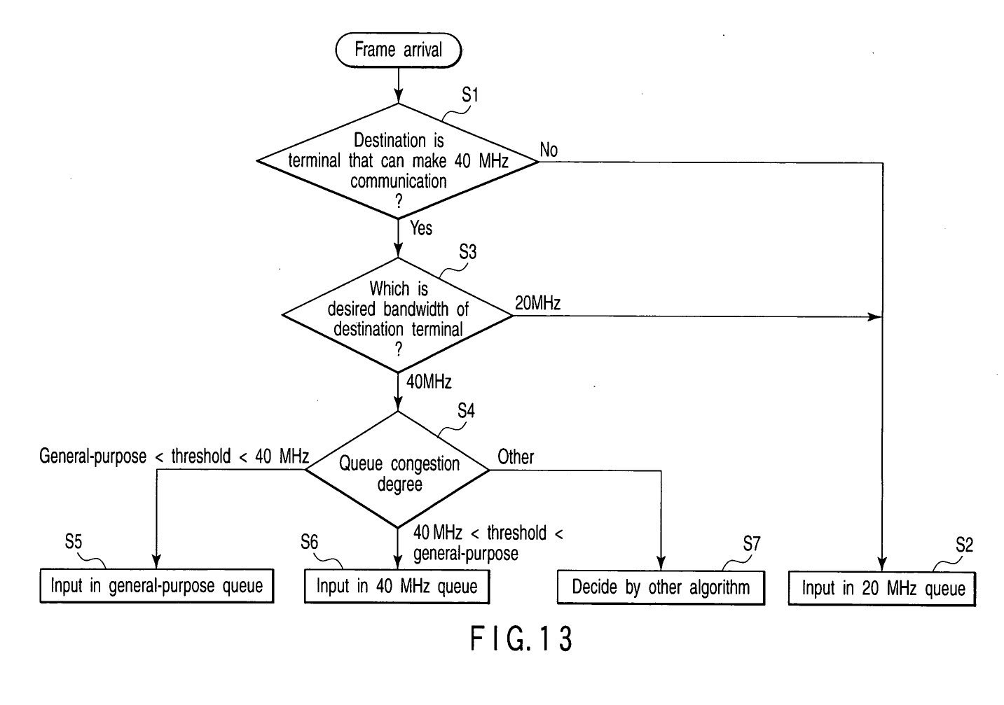

To attain a similar effect, as depicted in FIG. 13, the scheduler 1 may compare the queue congestion level of each queue with a prescribed threshold, and input the frame in a queue of which the queue congestion level is lower than the threshold. If either queue is higher or lower in queue congestion level than the threshold, the scheduler 1 inputs the frame in an appropriate queue. For example, if the frame is one with a low delay bound, or it is a voice frame, the scheduler 1 may input such a frame in the general-purpose queue Q3.

Adaptive control of values of a variety of parameters in the scheduler 1 in response to the queue congestion level produces the same effect. For instance, applying adaptive control to the value of the threshold of the delay bound in FIG. 5 in response to the queue congestion level is considered. If the queue congestion level of the 40 MHz queue Q2 is higher than that of the general-purpose queue Q3 by a difference of not less than a certain extent, the value of the threshold is made large. Thereby, it becomes difficult to input the frame into the 40 MHz queue Q2, and it becomes easy to input the frame into the general-purpose queue Q3. On the contrary, if the queue congestion level of the general-purpose queue Q3 is higher than that of the 40 MHz queue Q2 by a difference of more than a certain extent, the value of the threshold is made small. Therefore, it becomes harder to input the frame into the 40 MHz queue Q2, and easy to input the frame into the general-purpose queue Q3.

The scheduler 1 may dynamically re-input to the other queue the frame which has input once. For example, the scheduler 1 stores the time when inputting the frames in the queues for each frame. If the frame remains in the same queue although a prescribed time period has elapsed, the scheduler 1 moves the frame to another queue. The queue for the move destination is selected by taking a queue congestion level, a capability of the destination terminal, or a desired bandwidth into consideration.

At this time, when moving the frame from the MHz queue Q1 to the general-purpose queue Q3, or from the 20 MHz queue Q1 to the 40 MHz queue Q2, the scheduler refers to the table 5 to check whether the destination terminal of the frame to be moved is a terminal from/at which the frame can be transmitted/received only in the bandwidth of 20 MHz, or a terminal from/at which the frame can be transmitted/received also in the bandwidth of 40 MHz. If the terminal is one from/at which the frame can be transmitted/received in the bandwidth of 20 MHz, the MHz frame cannot be moved to the general-purpose queue Q3 or the 40 MHz queue Q2, and the frame remains in the 20 MHz queue Q1. On the contrary, to move the frame from the general-purpose queue Q3 to the 20 MHz queue Q1 or the 40 MHz queue Q2, or to move the frame from the 40 MHz queue Q2 to the general-purpose queue Q3 or the 20 MHz queue Q1, there is no need to check the capability of the destination terminal of the frame to be moved with reference to the table 5, as mentioned above.

When states of other queues are checked, and if there is no queue under conditions better than that of a current queue, the scheduler 1 may leave the frame in the current queue without having to move it. For instance, if the queue congestion level of other queues are higher than that of the current queue, the scheduler 1 does not move the frame.

Applying adaptive control like this, the scheduler 1 may reduce the possibility that the frame remains for a long time in the queue and that the frame is discarded when a transmission limit time arrives. Therefore, an effect, such as a reduction in frame waiting time at the queue and reduction in discard rate is obtained, and the improvement of the use efficiency or the throughput of the channel is achieved.

### THIRD EMBODIMENT

The configuration of the radio system in the third embodiment is the same as that of the first embodiment depicted in FIG. 1. The frequency channel arrangement in the third embodiment is the same as that of FIG. 2, and the media access control system is the same as that of FIG. 3. The third embodiment is different from the first embodiment in the configuration of a radio communication apparatus, a method in which the scheduler 1 decides which queue to input the frame, and a method in which the scheduler 2 decides which queue to output the frame.

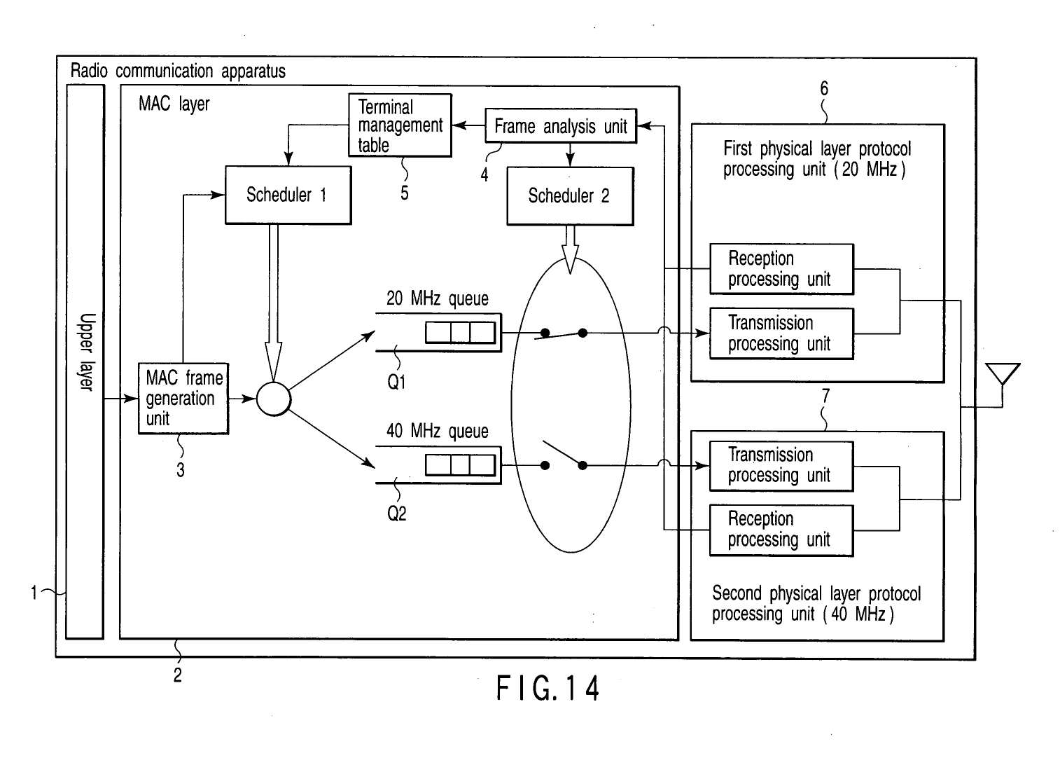

FIG. 14 shows the configuration of the radio communication apparatus in the third embodiment. The configuration is different from that of the first embodiment shown in FIG. 4 in that the configuration does not have the general-purpose queue Q3. The scheduler 1 inputs the frame in the 20 MHz queue Q1 or the 40 MHz queue Q2, and the scheduler 2 outputs the frame from the 20 MHz queue Q1 or the 40 MHz queue Q2. The frame output from the 40 MHz queue Q2 is transferred to the physical layer protocol processing unit 6 of 20 MHz, and the frame output from the 40 MHz queue Q2 is transferred to the physical layer protocol processing unit 7 of 40 MHz.

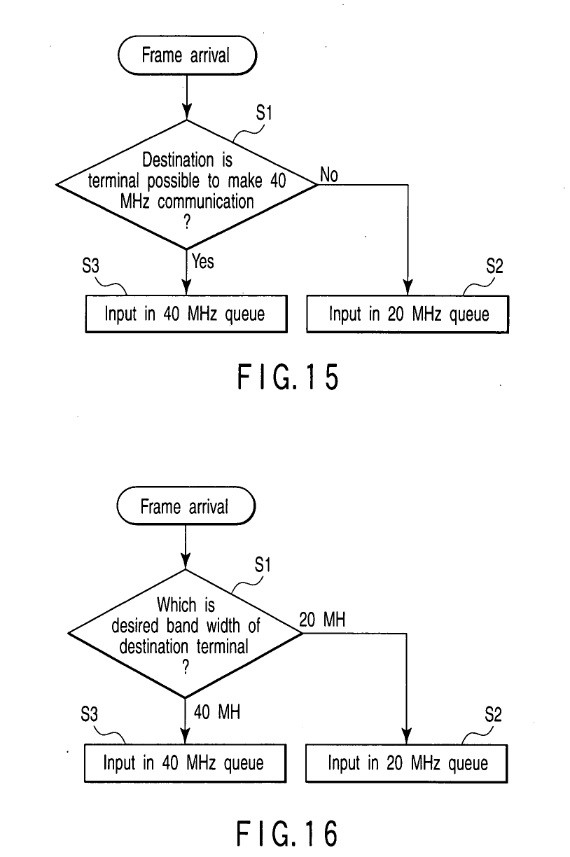

FIG. 15 illustrates a flowchart of an operation procedure of the scheduler 1 in the third embodiment. The scheduler 1 firstly checks the transmission destination address of the frame, refers to the terminal management table 5, and acquires information about whether the destination terminal is a terminal that can transmit/receive the frame only in the bandwidth of 20 MHz, or a terminal that can transmit/receive the frame also in the bandwidth of 40 MHz (step S1). If the terminal is one that can transmit/receive the frame only in the bandwidth of 20 MHz, the scheduler 1 inputs the frame in the 20 MHz queue Q1 (step S2). If the terminal is one that can transmit/receive the frame also in the bandwidth of the 40 MHz, the scheduler 1 inputs the frame in the 40 MHz queue Q2 (step S3).

FIG. 16 shows a flowchart of another operation procedure of the scheduler 1 in the third embodiment. The scheduler 1 firstly checks the transmission destination address of the frame, refers to the table 5, and acquires the information about whether the terminal desires to receive the frame in the bandwidth of 20 MHz or 40 MHz (step S1). If the terminal desires to receive the frame in the bandwidth of 20 MHz, the scheduler 1 inputs the frame in the 20 MHz queue Q1 (step S2). If the terminal desires to receive the frame in the bandwidth of 40 MHz, the scheduler 1 inputs the frame in the 40 MHz queue Q2 (step S3).

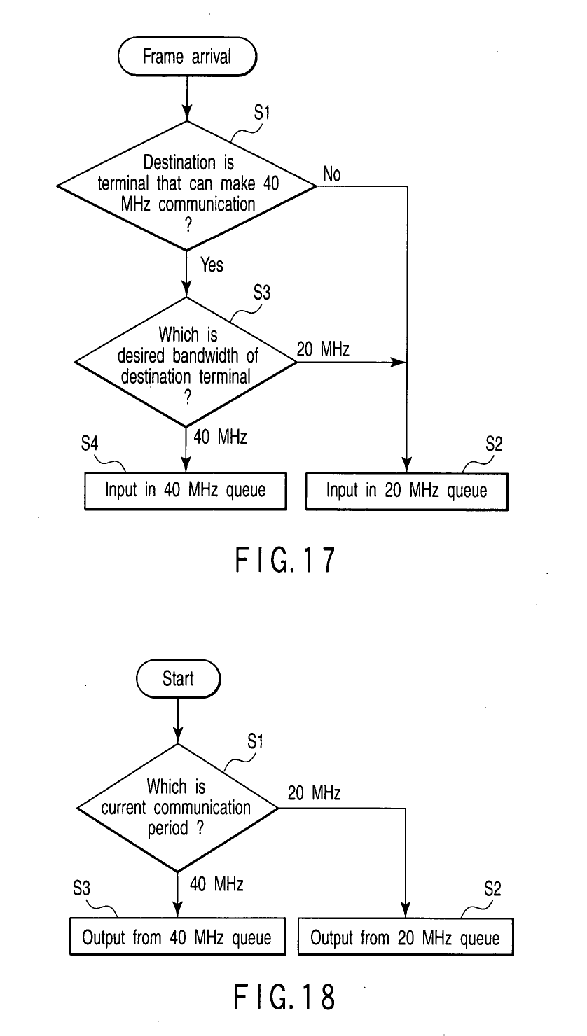

FIG. 17 depicts a flowchart of another operation procedure of the scheduler 1 in the third embodiment. The scheduler 1 firstly checks the transmission destination address of the frame, refers to the table 5, and acquires the information as to whether the terminal is a terminal that can transmit/receive the frame in the bandwidth of 20 MHz, or a terminal that can transmit/receive the frame also in the bandwidth of 40 MHz (step S1). If the terminal is one that can transmit/receive only in the bandwidth of 20 MHz, the scheduler 1 inputs the frame in the 20 MHz queue Q1 (step S2). If the terminal is one that can transmit/receive also in the bandwidth of 40 MHz, the scheduler refers to the table 5 again, and acquires the information on which of the bandwidths of 20 MHz and 40 MHz is desired to be used in receiving the frame by the terminal (step S3). If the terminal desires to receive the frame in the bandwidth of 20 MHz, the scheduler 1 inputs the frame in the 20 MHz queue Q1 (step S2). If the terminal desires to receive the frame in the bandwidth of 40 MHz, the scheduler 1 inputs the frame in the 40 MHz queue Q2 (step S4).

FIG. 18 illustrates a flowchart of an operation procedure of the scheduler 2 in the third embodiment. The scheduler 2 acquires any one piece of switching instruction information from the 20 MHz period to the 40 MHz period, switching instruction information from the 40 MHz period to the 20 MHz period, or information indicating if the radio communication apparatus is currently in the 20 MHz period or in the 40 MHz period, and the scheduler 2 extracts the frame from the corresponding queue in response to whether the apparatus is in the 20 MHz period or in the 40 MHz period (step S1). If the apparatus is in the 20 MHz period, the scheduler 2 extracts the frame from the MHz queue Q1 to transfer it to the processing unit 6 of 20 MHz (step S2). If the apparatus is in the 40 MHz period, the scheduler 2 extracts the frame from the 40 MHz period, and the scheduler 2 takes out the frame from the 40 MHz period to transfer it to the processing unit 7 of 40 MHz (step S3).

Accordingly, the apparatus like the STA1 that supports both 20 MHz and 40 MHz can transmit the frame through the channel 20 MHz_ch_a during the 20 MHz period, and through the channel 40 MHz_ch_a during the 40 MHz period in response to the instruction from the AP.

### FOURTH EMBODIMENT

The configuration of the radio system in the fourth embodiment is the same as that of FIG. 1. The frequency channel arrangement and the media access control system in this embodiment are the same as those of FIG. 2 and FIG. 3, respectively. This embodiment differs from the first embodiment in the configuration of the radio communication apparatus and in the operations of the scheduler.

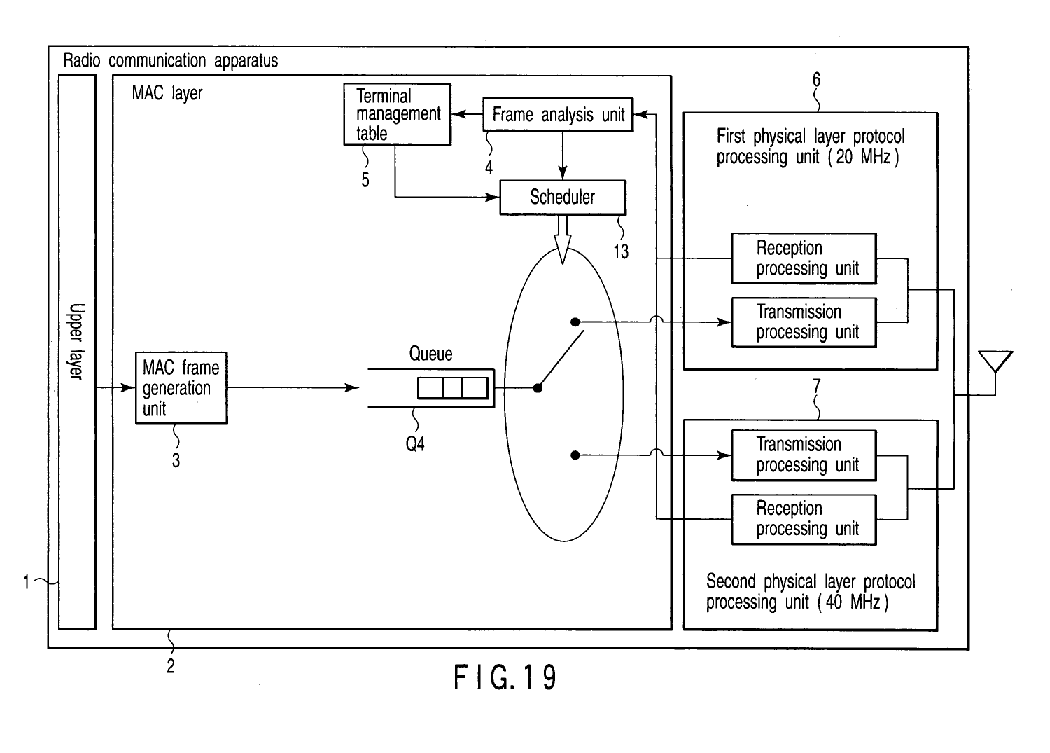

FIG. 19 shows the configuration of the apparatus in the fourth embodiment. The configuration is different from that of the first embodiment of FIG. 1 in that the number of queues and schedulers is one, respectively.

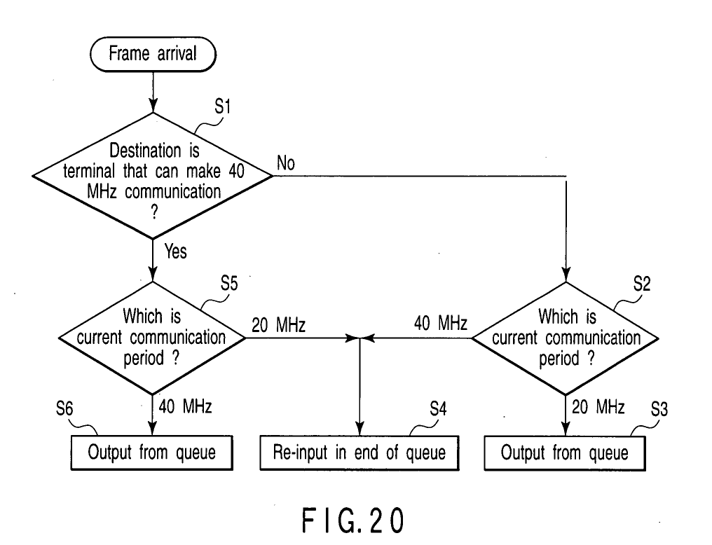

Frames are input to a queue Q4 without distinction of 20/40 MHz in order of arrival. FIG. 20 illustrates the flowchart of an operation procedure in the embodiment. A scheduler 13 takes out the frame from a queue Q4, checks a transmission destination address of the frame firstly, refers to the terminal management table 5, and acquires the information about if its transmission destination terminal is a terminal that can transmit/receive the frame only in the bandwidth of 20 MHz, or the terminal is one that can transmit/receive the frame also in the bandwidth of 40 MHz (step S1). If the terminal is one that can transmit/receive only in the bandwidth of 20 MHz, the scheduler 13 checks if the apparatus is now in the MHz period or in the 40 MHz period (step S2). If the apparatus is in the 20 MHz period, the scheduler 13 transfers the frame to the physical layer protocol processing unit 6 of 20 MHz (step S3). If it is in the 40 MHz period, the scheduler 13 re-inputs the frame at the end of the queue Q4 (step S4). The position to which the frame is re-input is not limited to the end of the queue Q4. For example, the frame may be returned to the head of the queue Q4 or at the middle of the queue Q4. The scheduler 13 may prepare another queue to store the frame in that frame until the end of the 40 MHz period, and output from another queue after starting the 20 MHz period to transfer it to the processing unit 6.

If the terminal can transmit/receive the frame also in the bandwidth of 40 MHz, the scheduler 13 checks if the apparatus is in the 20 MHz period or 40 MHz period (step S5). If it is in the 40 MHz period, the scheduler 13 transfers the frame to the physical layer protocol processing unit 7 of 40 MHz (step S6). If it is in the 20 MHz period, the scheduler 13 re-inputs the frame at the end of the queue Q4 (step Q4). In the same manner given above, the scheduler 13 may not limit the position to the end of the queue Q4, and may return the frame to the head of the queue Q4, and insert it at the middle of the queue Q4. The scheduler 13 may prepare another queue to store the frame in the queue until the 20 MHz period comes to an end, and after the start of the 40 MHz period, the scheduler 13 may output the frame from another queue to transfer it to the processing unit 7.

Even when the destination terminal is the terminal capable of transmitting/receiving the frame also in the bandwidth of 40 MHz, if the apparatus is now in the MHz period, the scheduler 13 may transfer the frame to the processing unit 6 of 20 MHz. Transferring the frame to the processing unit 6 of 20 MHz is a possible operation procedure only in the case in which it is confirmed, by referring to the table 5, that the destination terminal desires to receive the frame in the bandwidth of 20 MHz.

In this manner given above, the radio communication apparatus can obtain the same effect as that of the third embodiment, and the apparatus like the STA1 that supports both 20 MHz and 40 MHz can transmit the frame, in response to the instruction from the AP, by using the channel 20 MHz_ch_a in the 20 MHz period, and the channel 40 MHz_ch in the 40 MHz period. In comparison to the third embodiment, the apparatus has a smaller number of queues, and the configuration of the apparatus may be made simple. However, there is some possibility that the waiting time until the frame is transmitted becomes longer than that of the third embodiment.

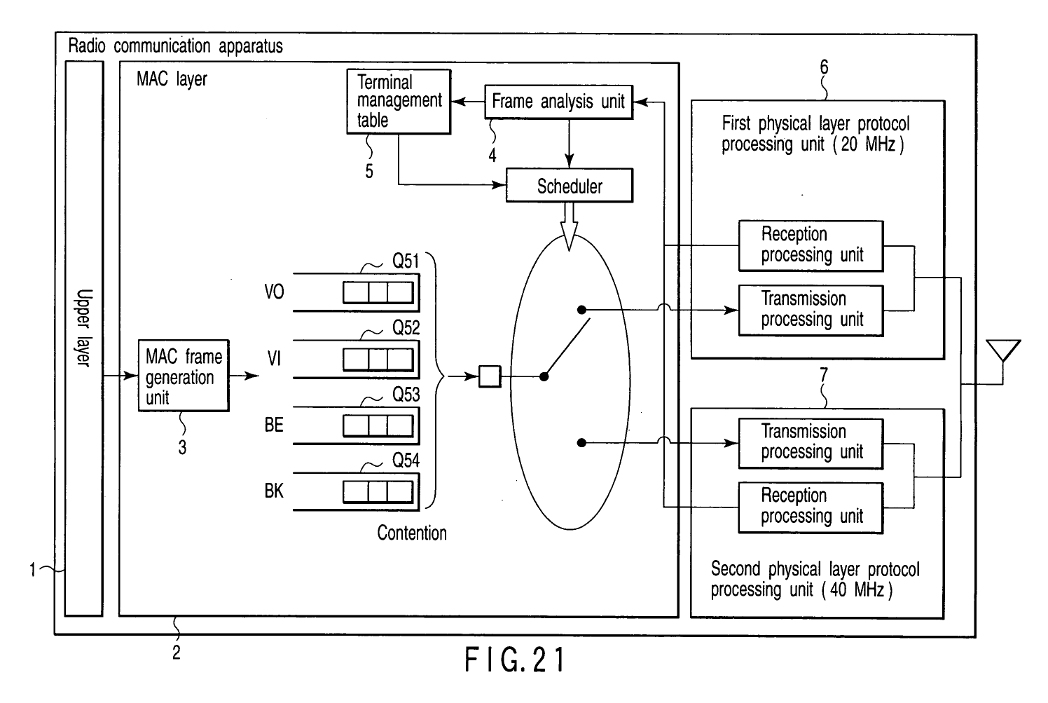

While the fourth embodiment has been described using an example in which the radio communication apparatus has one queue without distinction of 20/40 MHz, the configuration, as depicted in FIG. 21, having a plurality of sub-queues Q51-Q54 for each traffic class, is a possible approach. In such a configuration, one frame is selected from the plurality of sub-queues Q51-Q54 in accordance with, for example, an algorithm of the contention of IEEE 802.11e, and the scheduler 13 applies such a process given above to the frame.

### FIFTH EMBODIMENT

The configuration of the radio system in the fifth embodiment is the same as that of the first embodiment shown in FIG. 1. The frequency channel arrangement and the media access control system in this embodiment are the same as those of FIG. 2 and FIG. 3, respectively. This embodiment is different from the first embodiment in the configuration of the radio communication apparatus and in the method by which the scheduler 1 decides to which queue the frame is input.

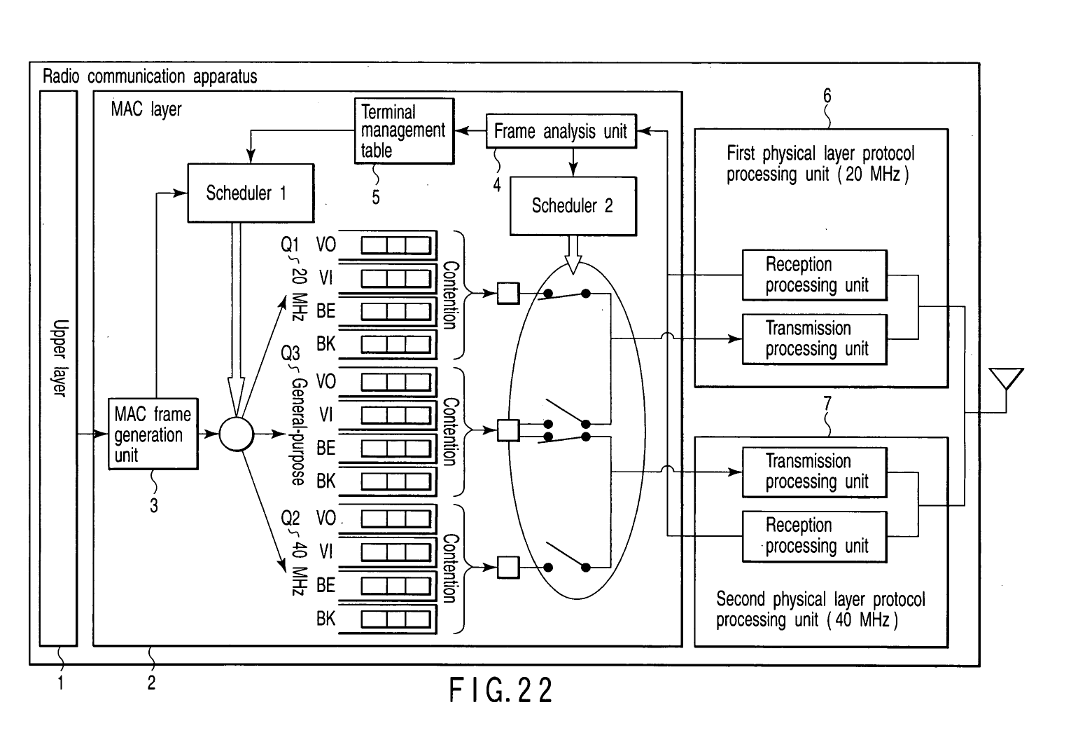

FIG. 22 shows the configuration of the radio communication apparatus in the fifth embodiment. The configuration of this embodiment differs from that of the first embodiment shown in FIG. 4 in that the configuration of this embodiment includes a plurality of queues for each traffic class for the respective 20 MH queue Q1, 40 MHz queue Q2 and general-purpose queue Q3. Here, an example is given in which the apparatus includes “20 MHz queue Q1 for voice traffic (VO)/20 MHz queue Q1 for moving image traffic (VI)/20 MHz queue Q1 for best effort traffic (BE)/20 MHz queue Q1 for control information (BK)”, “40 MHz queue Q1 for voice traffic (VO)/40 MHz queue Q1 for moving image traffic (VI)/40 MHz queue Q1 for best effort traffic (BE)/40 MHz queue Q1 for control information (BK)”, and “general-purpose queue Q3 for voice traffic (VO)/general-purpose queue Q3 for moving image traffic (VI)/general-purpose queue Q3 for best effort traffic (BE)/general-purpose queue Q3 for control information (BK)”.

The number and kinds of each queue are not limited particularly. For instance, a configuration consisting of 6 queues, namely such a configuration consisting of “20 MHz queue Q1 for best effort traffic/20 MHz queue Q1 for control information”, “40 MHz queue Q2 for best effort traffic/40 MHz queue Q2 for control information”, and “general-purpose queue Q3 for voice traffic/general-purpose queue Q3 for image moving traffic”, is a possible configuration. Such a configuration including queues for broadcast, and for multicast, and outputting the frame from these queues preferentially is a possible approach.

The scheduler 1 of the fifth embodiment performs, for example, the following operations. The scheduler 1 firstly decides which of the 20 MHz queue Q1/40 MHz queue Q2/general-purpose queue Q3 to input the frame in accordance with the same procedure as that of the first embodiment. After this, the scheduler 1 checks the information accompanying the frame to examine the traffic class of the frame. The traffic class is described in the header of the frame in many cases. The scheduler 1 inputs the frame in the queues of which the traffic classes are matched with those in the frame among the 20 MHz/40 MHz/general-purpose queues Q1, Q2 and Q3 composed of a plurality of queues.

As to an output method of the frame, the following method is a possible method. In each classification of the 20 MHz/40 MHz/general-purpose queues Q1, Q2 and Q3, the scheduler 1 performs contentions among four queues, “voice, moving image, best effort, and control”. As for an algorithm of the contention, the scheduler 1 employs, for example, an error-detecting code algorithm (EDCA) of IEEE 802.11e. For example, four queues, “voice, moving image, best effort, and control” of 20 MHz each perform back off, and one frame is taken out from the queue which firstly completed the back off. This frame becomes a representative frame of all the 20 MHz queues Q1. Similarly, frames are selected from the 40 MHz/general-purpose queues Q2, Q3. The scheduler 2 applies the same processing procedures as those of the first embodiment shown in FIG. 7-FIG. 9 to three frames selected from the 20 MHz/40 MHz/general-purpose queues Q1, Q2 and Q3, respectively, and decides which frame to output to a physical layer protocol processing unit.

The fifth embodiment has described an example of applying the EDCA of IEEE 802.11e as an algorithm of the contention, but other algorithms are also applicable. While an example in which each of the MHz queue Q1, 40 MHz queue Q2, and general-purpose queue Q3 has a plurality of queues for each traffic class has been described, it is not limited to the case in which the queue classification depends on the traffic class, and may depend on other concepts.

According to the fifth embodiment, the quality of service (QoS) control, such as IEEE 802.11e, may be employed under consideration of the classification depending on the traffic class.

### SIXTH EMBODIMENT

The configuration of the radio system in the sixth embodiment is the same as that of the first embodiment shown in FIG. 1. The frequency channel arrangement and the media access control system in this embodiment are the same as those of FIG. 2 and FIG. 3, respectively. The configuration of the radio communication apparatus is the same as that of FIG. 4. This embodiment is different from the first embodiment in the operations of the scheduler 1 and the scheduler 2.

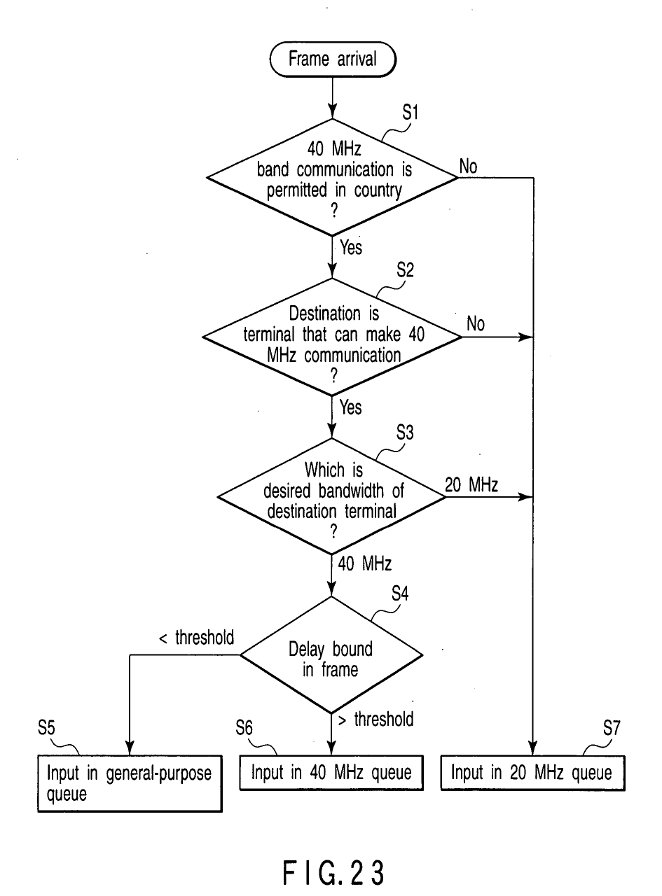

FIG. 23 illustrates the flowchart of the operations of the scheduler 1 in the sixth embodiment. The scheduler 1 operates in almost the same way as those of the first to fifth embodiments, however as of February, 2006, the use of the 40 MHz communication band is allowed in, for instance, U.S.A., but not allowed in Japan. Therefore, even if the configuration of the radio communication apparatus, as depicted in FIG. 4, includes the 40 MHz queue Q2 and the physical layer protocol processing unit 7 of 40 MHz, it may not be necessary to use such a type of the radio communication apparatus in a country such as Japan, in which the 40 MHz communication band cannot be used.

In taking such a point into account, the scheduler 1 checks the country number with the radio communication apparatus installed therein in preference to all other steps of processing. The country number is described in the control information frame, such as a beacon frame, to be transmitted from the AP. In the STA1 in FIG. 1, the frame analysis unit 4 of FIG. 4 analyzes the control information frame to be broadcast-transmitted from the AP to obtain the country number. Thereby, the STA1 may determine the country with the BSS installed therein. The STA1 may notify the obtained country number directly to the scheduler 1, store it in the terminal management table 5, and refer to the information if necessary.

If the checking result of the country number shows the country that can use the 40 MHz communication band (YES, in step S1), both schedulers 1 and 2 operate in the same manner as that of the first embodiment (steps S3-S7). On the contrary, if the 40 MHz communication band cannot be used in such country (No, step S1), the scheduler 1 inputs all frames in the 20 MHz queue (step S7). The scheduler 2 always takes out the frame from the 20 MHz queue Q1 to transfer it to the processing unit 6 of 20 MHz.

According to the sixth embodiment, even the radio communication apparatus that supports both 20/40 MHz communication bands, it operates in accordance with the country in which it is placed, and can obey the laws in each country.

### SEVENTH EMBODIMENT

The configuration of the radio system in the seventh embodiment is the same as that of the first embodiment shown in FIG. 1. The frequency channel arrangement and the media access control system in this embodiment are the same as those of FIG. 2 and FIG. 3, respectively. The configuration of the radio communication apparatus is the same as that of FIG. 4. This embodiment is different in the method by which the scheduler 1 decides in which queue the frame is to be input.

In the embodiments mentioned above, the frames addressed to the terminals corresponding to both 20/40 MHz communication bands are transmitted through both 20 MHz and 40 MHz communication bands. In the case of the radio communication apparatus of the configuration shown is FIG. 4, the waiting times from the times of input of the frames to the times of output of the frames differ depending on the congestion extents of each queue, and there is some possibility that the transmission order of the frames in an upper layer 1 is changed.

For example, it is considered that two frames, A and B, arrive in the MAC layer 2 in the order of A and B. It is presumed that the frame A is input in the 40 MHz queue Q2, the frame B is input in the general queue Q3, and the 40 MHz queue is more congested than the general-purpose queue Q3. In this case, the frame B is firstly transmitted, and the radio communication apparatus on the reception side receives the frames in reversed order. Such reversing of the arrival order can be performed by a mechanism on the reception side in the MAC layer 2, but reversing is not preferable to be performed in the upper layer 1, such as a TCP and UDP. Especially, the UDP does not re-transmit, so it is preferable for the frames to be transmitted in correct order.

Therefore, in the seventh embodiment, when the scheduler 1 distributes the frames to the queues, it inputs frames, being addressed to the same destination terminal and also having the same traffic stream ID (TID), integrally to either the 40 MHz queue or the MHz queue Q1. More specifically, when a request for transmitting the frames according to the order of transferred data from the upper layer 1 to the MC layer 2 is made from the radio communication apparatus on a transmission side, the scheduler 1 always inputs the data stream in the same queue.

Thereby, in the session in the upper layer 1, the radio communication apparatus on the reception side may receive the data, without the order being reversed.

### Eighth Embodiment

The configuration of the radio system in the eighth embodiment is the same as that of the first embodiment shown in FIG. 1. The frequency channel arrangement and the media access control system in this embodiment are the same as those of FIG. 2 and FIG. 3, respectively. This embodiment is different from the first embodiment in the configuration of the radio communication apparatus.

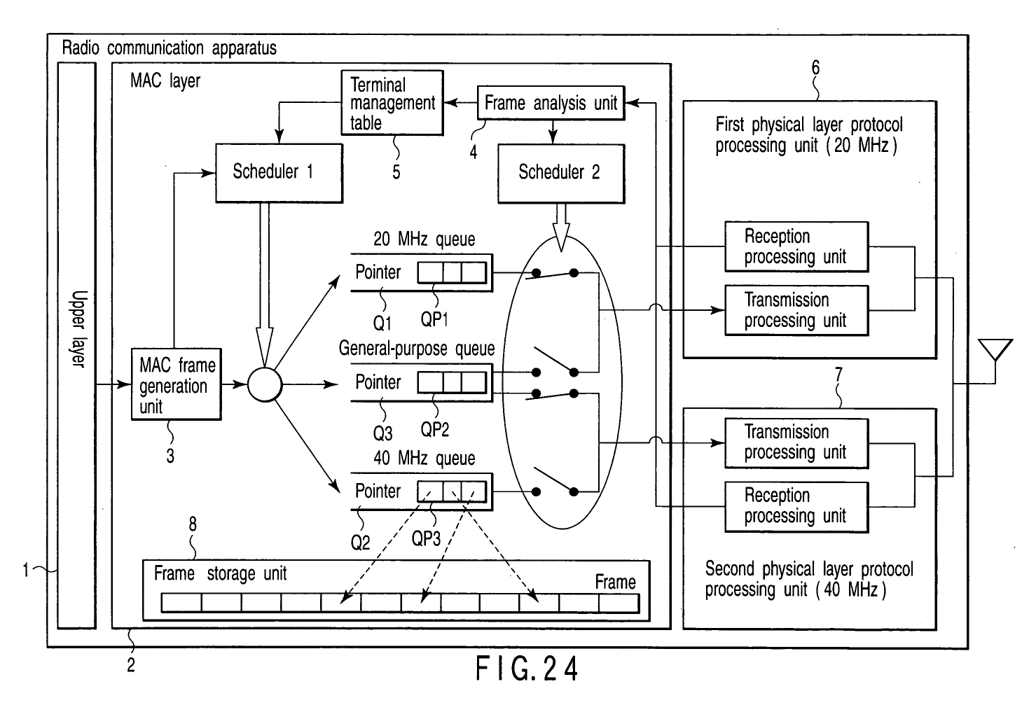

FIG. 24 shows the configuration of the radio communication apparatus in the eighth embodiment. The configuration of the apparatus in the eighth embodiment differs from that of the first embodiment in that there is a frame storage unit 8 other than the queues Q1-Q3.

In the eighth embodiment, the frames are stored in the storage unit 8 which has been prepared separately from the queues, and pointers QP1-QP3 indicating each frame are stored in each queue Q1-Q3. The frames generated from the MAC frame generation unit 3 of FIG. 4 are stored in the frame storage unit 8, not in each queue Q1-Q3. The scheduler 1 inputs the pointers QP1-QP3 indicating each frame in each queue Q1-Q3 in accordance with either algorithm mentioned in the first-the seventh embodiments. The scheduler 2 outputs the pointers QP1-QP3 from the queues Q1-Q3 in accordance with either algorithm mentioned in the first-the seventh embodiments, reads out the frames indicated by the pointers QP1-QP3 from the storage unit 8, and transfers them to the corresponding physical layer protocol processing units.

While the eighth embodiment has been described with reference to the first embodiment, other embodiments given above may similarly operate by inputting the pointers instead of frame main bodies.

According to the eighth embodiment, the apparatus may perform only processing of replacement of the pointers without having to rearrange the frames themselves in scheduling. Thereby, the apparatus may reduce in memory access and a processing amount, such as a sorting, writing and deleting of frames to shorten the processing time.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communication apparatus, comprising:
a first processing unit which performs physical layer protocol processing in order to make a radio communication using at least one first channel having a first frequency bandwidth;
a second processing unit which performs physical layer protocol processing in order to make a radio communication using a second channel which has a second frequency bandwidth having a bandwidth wider than that of the first frequency band and overlapping with the first frequency band;
a queue which stores a transmission frame including either information of a traffic class, a capability of a destination terminal, a recommended bandwidth by the destination terminal, and a time limit to complete transmission of a frame; and
a scheduler which controls a time when the transmission frame is output from the queue, and which of the first and the second processing units should be used for the output transmission frame, based on the information.

2. The apparatus according to claim 1, wherein
the queue includes a first queue which outputs the transmission frame to the first processing unit, a second queue which outputs the transmission frame to the second processing unit, and a third queue which outputs the transmission frame to at least one of the first and the second processing units, and
the scheduler includes:
a first scheduler which controls so that the transmission frame is input in either one of the first to third queues; and
a second scheduler which controls so that the transmission frame is output from the first queue or the third queue to be input to the first processing unit in a first period making the radio communication using the first channel, and so that the transmission frame is output from the second queue or the third queue to be input to the second processing unit in a second period making the radio communication using the second channel.

3. The apparatus according to claim 2, further comprising:
a first acquisition unit which acquires a first to a third queue congestion level in each queues, wherein
the first scheduler decides in which of the first queue and the third queue the transmission frame is to be input on the basis of a comparison result between the first congestion level and the third congestion level, and decides in which of the second queue and the third queue the transmission frame is to be input on the basis of a comparison result between the second congestion level and the third congestion level.

4. The apparatus according to claim 3, wherein:
the first congestion level indicates an averaged time from the time when the transmission frame is input in the first queue up to the time when the transmission frame is output;
the second congestion level indicates an averaged time from the time when the transmission frame is input in the second queue up to the time when the transmission frame is output; and
the third congestion level indicates an averaged time from the time when the transmission frame is input in the third queue up to the time when the transmission frame is output.

5. The apparatus according to claim 2, further comprising:
a second acquisition unit which acquires information which can determine whether or not the radio communication using the second channel is permitted at a place at which a basic service set (BSS) is installed, wherein
the first scheduler prohibits the transmission frame to be input in the second queue if the radio communication using the second channel is not permitted.

6. The apparatus according to claim 2, wherein
the first scheduler inputs a transmission frame which has a traffic class with high priority including at least a voice or a video to the third queue, and
the second scheduler outputs the transmission frame from the third queue in priority to the first and the second queues in both the first and the second periods.

7. The apparatus according to claim 2, wherein
the second scheduler compares a first time limit to complete transmission of the frame in the first queue with a second time limit to complete transmission of the frame in the third queue, and
outputs the frame having a shorter time until a time limit to complete transmission of a frame arrives, in priority to the other transmission frame.

8. The apparatus according to claim 7, wherein
the second scheduler further compares a third time limit to complete transmission of the frame in the second queue with a fourth time limit to complete transmission of the frame in the third queue, and
outputs the frame, having a shorter time until a time limit to complete transmission of a frame arrives, in priority to other transmission frame.

9. The apparatus according to claim 8, wherein
the second scheduler obtains a start time of the next first period which starts after the second period following the current first period,
outputs the first transmission frame in priority the second transmission frame if the first time limit to complete transmission of the frame comes earlier than the start time, and
outputs the third transmission frame in priority to the fourth transmission frame if the third time limit to complete transmission of the frame comes earlier than the start time.

10. The apparatus according to claim 2, further comprising:
a third acquisition unit which acquires each congestion level of the first to the third queues, wherein
the first scheduler preferentially inputs the transmission frame in a queue having a lower congestion level.

11. The apparatus according to claim 10, wherein the first scheduler moves the transmission frame from a queue with a higher congestion level to a queue with a lower congestion level.

12. The apparatus according to claim 3, wherein the congestion level is either a number of frames in a queue, a number of total data bites in the queue, a number of frames in the queue/a queue length, a number of total data bites in the queue/a queue length, or empty size of the queue.

13. The apparatus according to claim 9, wherein the congestion level is either a number of frames in a queue, a number of total data bites in the queue, a number of frames in the queue/a queue length, a number of total data bites in the queue/a queue length, or empty size of the queue.

14. The apparatus according to claim 10, wherein the congestion level is either a number of frames in a queue, a number of total data bites in the queue, a number of frames in the queue/a queue length, a number of total data bites in the queue/a queue length, or empty size of the queue.

15. A radio communication method, comprising:
performing physical layer protocol processing for making a radio communication using at least one first channel having a first frequency bandwidth by a first processing unit;
performing physical layer protocol processing for making a radio communication using a second channel which has a second frequency bandwidth having a bandwidth wider than that of the first frequency band and overlapping with the first frequency band by a second processing unit;
storing a transmission frame including information of either a traffic class, a capability of a destination terminal, a recommended bandwidth by the destination terminal, and a time limit to complete transmission of a frame in a queue; and
controlling a time when the transmission frame is output from the queue, and which of the first processing unit and the second processing unit should be supplied the output transmission frame on the basis of the information.
